(19) United States
(12) Patent Application Publication
(10) Pub. No.: US 2025/0049029 A1
(43) Pub. Date: Feb. 13, 2025

(54) Agrochemical Compositions

(71) Applicant: Syngenta Crop Protection AG, Basel (CH)

(72) Inventors: Kingsley Horton NELSON, Jr., Greensboro, NC (US); Dallas Guy KESLER, Greensboro, NC (US)

(73) Assignee: Syngenta Crop Protection AG, Basel (CH)

(21) Appl. No.: 18/720,050

(22) PCT Filed: Dec. 12, 2022
(86) PCT No.: PCT/EP2022/085406

§ 371 Date: Jun. 14, 2024

Related U.S. Application Data
(60) Provisional application No. 63/328,785, filed on Apr. 8, 2022.
(60) Provisional application No. 63/290,929, filed on Dec. 17, 2021.

(51) Int. Cl. A01N 37/22; A01N 25/04; A01N 25/28; A01N 43/653; A01N 43/707; A01P 13/00

(52) U.S. Cl. CPC A01N 37/22; A01N 25/04; A01N 25/28; A01N 43/653; A01N 43/707; A01P 13/00

(57) ABSTRACT

A composition, having a liquid continuous phase, a first agrochemical active ingredient which is insoluble in the liquid continuous phase, a second agrochemical active ingredient or solvent which dissolves the first agrochemical active ingredient encapsulated in a permeable capsule, the permeable capsule dispersed within the liquid continuous phase, and a stabilizing amount of the second agrochemical active ingredient free in the liquid continuous phase which dissolves the first agrochemical active ingredient, as well as, methods of making and use.

### CROSS-REFERENCE TO RELATED APPLICATIONS

This application claims the benefit of U.S. Provisional Application Ser. No. 63/290,929, filed Dec. 17, 2021, and U.S. Provisional Application Ser. No. 63/382,785, filed Nov. 8, 2022, the entire contents of each are incorporated by reference herein.

### TECHNICAL FIELD

The present invention relates to compositions comprising a combination of crop protection compounds, and a method of preparing and the use of such a composition.

### BACKGROUND

By 2050, the global population is expected to reach 9.7 billion people. Such an increase would require a 60% increase in food production compared with 2005-2007 levels. To this end, agrochemical compositions are used to facilitate the growth and health of crops thereby improving yields.

However, one challenge is effectively distributing agrochemical to a farmer, or group thereof. This is because the growing of crops is usually regionally coordinated. As a result, e.g., all plantings occur around the same window. Failure to plant within an acceptable window can result in crop loss and unprofitability.

To help meet demand, agrochemical compositions need to be sufficiently storage stable so that the agrochemical compositions can be stockpiled until sold or held over to the next year avoiding waste.

One common challenge for agrochemical compositions is preventing crystallization of agrochemicals within the composition. Crystallization of agrochemicals within a composition can create issues in application by clogging equipment or uneven application. Furthermore, crystallization can lead to settling of the agrochemical, thereby impacting overall physical stability.

Commercial formulations with metribuzin as a particle are known to suffer crystal growth upon storage at high temperature and ambient temperature due to partial solubility in water. This is particularly highlighted by Sencoral™ and Sencor™, from Bayer, and as shown in FIG. 1.

Accordingly, there remains a need for agrochemical compositions which mitigate crystallization of the agrochemicals within.

### SUMMARY

Embodiments include a composition, having a liquid continuous phase, a first agrochemical active ingredient which is insoluble in the liquid continuous phase, a second agrochemical active ingredient which dissolves the first agrochemical active ingredient encapsulated in a permeable capsule, the permeable capsule dispersed within the liquid continuous phase, and a stabilizing amount of the second agrochemical active ingredient free in the liquid continuous phase which dissolves the first agrochemical active ingredient.

Further embodiments include a composition, having a liquid continuous phase, a first agrochemical active ingredient which is insoluble in the liquid continuous phase, a solvent which dissolves the first agrochemical active ingredient encapsulated in a permeable capsule, the permeable capsule dispersed within the liquid continuous phase, and a stabilizing amount of the solvent ingredient free in the liquid continuous phase which dissolves the first agrochemical active ingredient.

Additional embodiments include a method of weed control, by diluting the composition described above and applying an herbicidal amount of the composition to a crop or the locus of the crop.

Another embodiment disclosed is a method, including encapsulating a second agrochemical active ingredient in a permeable capsule to form a first composition, combining the first composition with the first agrochemical active ingredient to form a composition as defined above.

### BRIEF DESCRIPTION OF DRAWINGS

FIG. 1 shows images related to crystal growth in Sencoral™ and Sencor™

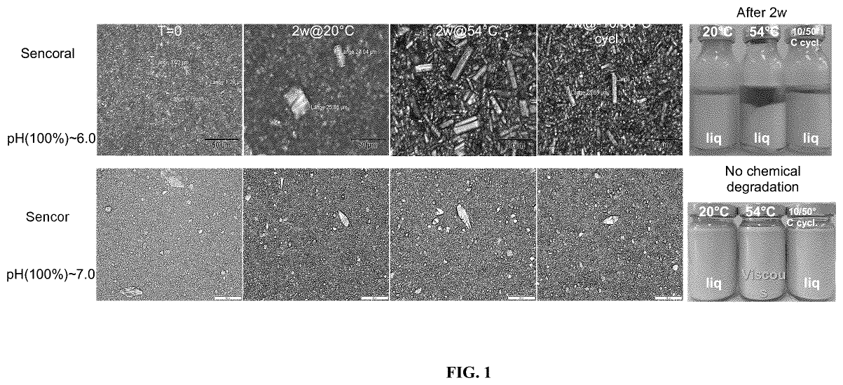

FIGS. 2A and 2B are graphs showing particle size over time in a composition of the disclosure and comparison product.

FIGS. 3A, 3B, and 3C show micrographic images of compositions after two to four weeks at elevated temperature.

FIGS. 4A and 4B show micrographic images of a composition containing metribuzin and a composition with the subsequent addition of a permeable capsule suspension containing S-metolachlor.

FIG. 5 shows a micrographic image of a composition of sulfentrazone and a permeable capsule suspension containing S-metolachlor.

### DETAILED DESCRIPTION

Before certain embodiments are described in greater detail, it is to be understood that this disclosure is not limited to certain embodiments described, as such may, of course, vary. It is also to be understood that the terminology used herein is for the purpose of describing certain embodiments only, and is not intended to be limiting, since the scope of the present disclosure will be limited only by the appended claims.

Described herein are several definitions. Such definitions are meant to encompass grammatical equivalents.

The use of “or” means “and/or” unless stated otherwise. Furthermore, the use of the terms “comprising.” “having.” “including,” as well as other forms, such as “includes” and “included,” are intended to be inclusive and mean that there may be additional elements other than the listed elements.

As used herein, the term “about” when referring to a measurable value such as an amount, a temporal duration, and the like, is meant to encompass variations. Such variations, however, are dependent on the specific component referred to and the context as understood by a person of ordinary skill in the art.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, representative illustrative methods, and materials are now described.

Each of the individual embodiments described and illustrated herein has discrete components and features which may be readily separated from or combined with the features of any of the other several embodiments without departing from the scope or spirit of the present disclosure. Any recited method can be carried out in the order of events recited or in any other order which is logically possible.

Embodiments of the disclosure can be practiced without any component not specifically mentioned in this disclosure.

Embodiments described herein may comprise, consist essentially of, or consist of the elements therein.

As used herein, the term “a stabilizing amount” refers to an amount of a component which provides stability to the formulation. Such stabilization includes the prevention of unwanted crystal growth/particle agglomeration. In general, this means that the average particle size in the composition does not increase more than 10%, 15%, 20%, 25%, 30%, 40%, or 50% during storage, e.g., at 50° C. for 4-weeks.

As used herein, the term “permeable,” and the like, refers to a material or membrane which allows liquids or gases to pass through it. The permeability of the encapsulation material can be controlled through various means, e.g., by the amount of cross-linking to the encapsulation material or the total amount of encapsulation material being used. Permeability may also depend on the specific encapsulating material and material being encapsulated.

In specific embodiments, the total amount of encapsulation material (e.g., a polymer) can be less than 20% w/w of the total composition, less than 15% w/w of the total composition, less than 10% w/w of the total composition, or less than 5% w/w of the total composition.

In certain embodiments, the amount of encapsulation material can be defined relative to the amount of material being encapsulated. For example, the w/w ratio of encapsulating material to the material being encapsulated can be 1:5 to 1:25, 1:8 to 1:18, 1:10 to 1:15, or about 1:12.

The permeability of the encapsulation material allows the encapsulated material to be in communication with the continuous phase. The permeability of the encapsulation material can allow, e.g., less than 10% w/w, less than 9% w/w, less than 8% w/w; less than 7% w/w; less than 6% w/w, less than 5% w/w, less than 4% w/w, less than 3% w/w, less than 2% w/w, or less than 1% w/w, or any range from these number, e.g., 1 to 10% w/w, 2 to 5% w/w, or 1 to 3% w/w to enter into the continuous phase.

In specific embodiments, the amount of encapsulated material can be selected such that the first agrochemical material can be completely solubilized by the encapsulated. This amount can readily be determined based on the solubility of the first agrochemical in the encapsulated material. In certain embodiments, the amount of encapsulated material is less than the total amount able to solubilize the first encapsulated material. Certain embodiments are configured such that the amount of free encapsulated material is less than the total amount necessary to completely solubilize the first agrochemical material, however, the first agrochemical will still be completely solubilized.

### Compositions

The compositions described herein are preferably ‘ZC’ formulations. ZCs comprise a stable suspension of capsules (CS) and active ingredient(s) in fluid (SC).

### Agrochemicals

The term agrochemical active ingredient includes compounds or ingredients registered as being biologically active against an agricultural pest. In general, agrochemical active ingredients include compounds listed in: The Pesticide Manual, 12th edition, 2001, British Crop Protection Council. Agrochemicals include, but are not limited to herbicides, fungicides, insecticides, bactericides, insect growth regulators, plant growth regulators, nematicides, molluscicides or mixtures of several of these preparations. The total amount of active ingredients is generally in the range of from about 1-60% w/w, preferably 5% to 55% w/w; and most preferably 15% to 35% w/w. In specific embodiments, the amount of each active ingredient is between about 2-40% w/w, preferably about 5-35% w/w; more preferably about 10-30% w/w, and most preferably about 10-20% w/w. In alternative embodiments, for example in diluted formulations, the total amount of the agrochemicals in the composition is from 0.002% to 5% w/w; preferably 0.01% to 3% w/w; and most preferably 0.02% to 1.75% w/w.

Five particular agrochemicals are S-metolachlor (S-MOC), metribuzin, cloransulam-methyl, and mesotrione. S-MOC is part of the chloroacetanilide family of herbicides, used to control grasses and broad-leafed weeds, often in maize. Acetamide herbicides are a group of structurally related herbicides that include acetanilide herbicides (e.g., chloroacetanilide herbicides) and other amide-containing herbicides. Metribuzin is an herbicide used both pre- and post-emergence in crops and acts by inhibiting photosynthesis by disrupting photosystem II. Cloransulam-methyl is a sulfonamide used as an herbicide for the of post-emergence control of broad-leaved weeds. Mesotrione is a 4-hydroxyphenylpyruvate dioxygenase (HPPD) inhibitor. Sulfentrazone is in the aryl triazinone chemical class of herbicides and controls weeds by inhibiting the protoporphyrinogen oxidase (PPO) enzyme in plants

The structures of these components are shown in Table 1.

TABLE 1

| Compound | Structure |
|---|---|
| S-metolachlor | 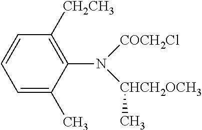 |
| Metribuzin | 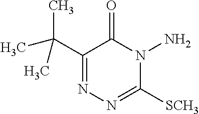 |
| Cloransulam- methyl | 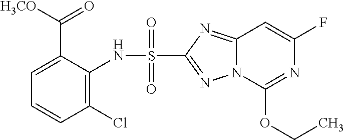 [SMILES: CCOc1nc(F)cc2nc(S(=O)(=O)Nc3c(Cl)cccc3C(=O)OC)nn12] |
| Mesotrione | 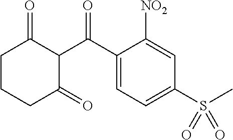 [SMILES: CS(=O)(=O)c1ccc(C(=O)C2C(=O)CCCC2=O)c([N+](=O)[O-])c1] |
| Sulfentrazone | 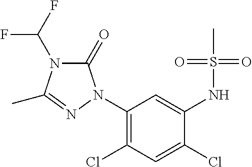 [SMILES: Cc1nn(-c2cc(NS(C)(=O)=O)c(Cl)cc2Cl)c(=O)n1C(F)F] |

In some embodiments, the S-metolachlor may be present in an amount of from 15 to 55% by weight, such as from 20 to 50% by weight, preferably from 25 to 45% by weight, or even from about 30 to 40% by weight.

In some embodiments, the metribuzin may be present in an amount of from 1 to 20% by weight, such as from 2 to 15% by weight, preferably, from 5 to 10% by weight, or even from 6 to 8% by weight.

In some embodiments, the cloransulam-methyl is present in amount of from 0.01 to 10% by weight, such as from 0.1 to 5% by weight, preferably from 0.4 to 1% by weight, such as from 0.5 to 0.9% by weight.

In some embodiments, the mesotrione may be present in an amount of from 1 to 20% by weight, such as from 2 to 10% by weight, preferably, about 3% by weight. Alternatively, mesotrione can be any one, or combination of 1, 2, 3, 4, 5, 6, 7, 8, 9, 10% by weight.

In some embodiments, the sulfentrazone is present in amount of from 0.01 to 10% by weight, such as from 0.1 to 5% by weight, preferably from 0.5 to 4% by weight, such as from 0.1 to 3% by weight.

In one embodiment, the composition comprises, from 400 to 420 g/L S-metolachlor, from 75 to 78/L metribuzin, and from 6 to 8 g/L cloransulam-methyl.

The compositions preferably comprise one or more dispersing agents, more preferably the dispersing agent is selected from 2-[methyl-(1-oxo-9-octadecenyl)-amino]-ethanesulfonic acid, and/or lignins: or salts thereof.

The composition preferably comprises one or more surfactants as wetting agents and/or emulsifiers and/or dispersants. The one or more surfactants is/are present in an amount of from 1 to 15% by weight, such as from 2 to 14% by weight, or from 3 to 12% by weight.

Suitable ionic surfactants are the alkali, alkaline earth and ammonium salts of aromatic sulphonic acids, for example of lignosulphonic acid, phenolsulphonic acid, naphthalenesulphonic acid, dibutylnaphthalenesulphonic acid or of fatty acids, alkyl- and alkylarylsulfonates, alkylsulphates, lauryl ether sulphates and fatty alcohol sulphates, and salts of sulphated hexa-, hepta- and octa-decanols, and of fatty alcohol glycol ethers, condensates of sulfonated naphthalene and its derivatives with formaldehyde, condensates of naphthalene or of the naphthalenesulphonic acids with phenol and formaldehyde, polycarboxylates or phosphate esters of alkoxylated alcohols.

Suitable nonionic surfactants are polyoxyethylene octyl phenol ethers, alkoxylated alcohols such as ethoxylated isooctyl-, octyl- or nonyl-phenol, alkylphenyl polyglycol ethers, tributylphenyl polyglycol ethers, alkylaryl polyether alcohols, isotridecyl alcohol, fatty alcohol/ethylene oxide condensates, ethoxylated castor oil, polyoxyethylene alkyl ethers or polyoxypropylene alkyl ethers, lauryl alcohol polyglycol ether acetate, sorbitol esters, lignin-sulfite waste liquors and also proteins, denatured proteins, polysaccharides (for example methylcellulose), hydrophobically modified starches, polyvinyl alcohols (for example Mowiol®), polyalkoxylates, polyvinylamines, polyethyleneimines, polyvinylpyrrolidones and their copolymers or block polymers.

The compositions preferably comprise naphthalenesulfonic acid, sodium salt condensed with formaldehyde as a wetting agent.

Stabilizing agents, such as ammonium nitrate, can be present in the composition from, e.g., 0.1 to 2% w/w or about 1% w/w. The stabilizing agent can be used in an amount to improve dilution performance.

The compositions can comprise an ethoxylated alcohol as an emulsifier. Preferably the ethoxylated alcohol has an alkyl chain of from C₂ to C₃₀, such as from C₅ to C₂₀, from C₁₀ to C₁₈, or even from C₁₂ to C₁₅. The ethoxylated alcohol may have from 5 to 30, such as from 10 to 25, preferably 20 ethoxylate monomers.

The compositions may comprise an anti-foam agent, preferably polydimethylsiloxane. Advantageously, the anti-foam agent is present in an amount of from 0.001 to 0.1% by weight, such as from 0.005 to 0.015% by weight.

The compositions may contain an anti-freeze agent, preferably a glycol, such as propane-1,2-diol. The anti-freeze agent can be present in an amount of from 0.01 to 5% by weight or from 0.1 to 5% by weight, such as from 0.5 to 2% by weight.

The composition may contain a thickener or rheological modifier, such as xanthan gum. The thickener can be present in an amount of from 0.01 to 5% by weight or from 0.01 to 3% by weight, such as from 0.05 to 2% by weight.

The composition may contain a preservative agent or an anti-bacterial agent, such as 2-bromo-2-nitropropan-1,3-diol, 5-chloro-2-methyl-4-isothiazolin-3-one and/or 2-methyl-4-isothiazolin-3-one. The anti-bacterial agent can be present in amount of from 0.01 to 1% by weight, such as from 0.05 to 0.15% by weight.

The compositions may include other ingredients such as a colourant and a perfume, which are well known to the man skilled in the art.

The compositions can include adjuvants. Examples are surfactants (e.g. non-ionic, anionic, cationic or amphoteric), wetting agents, spreading agents, sticking agents, humectants and penetration agents. Further examples of suitable adjuvants are mineral oils, vegetable oils, fatty acid esters, esters of aliphatic or aromatic dicarboxylic acids, alcohol ethoxylates, alkylphenol ethoxylates, alkylamine ethoxylates, ethoxylates of triglycerides, ethoxylates of fatty acids, ethoxylates of fatty acid esters, ethoxylates of sorbitan fatty acid esters, alkyl polyglycosides and silicone-based adjuvants. Preferred suitable adjuvants are surfactants which provide improved wetting or improved spray retention properties.

The composition herein can relate to compositions produced in a farmer's spray tank of water when a concentrate is mixed with water in the spray tank. A composition of the present invention may be in the form of a pre-mix formulation, packaged within a single vessel and ready to use directly after dilution. Thus, there is provided the use of the composition wherein such use comprises a dilution step prior to application.

The composition can be combined with at least one further active ingredient, typically another agrochemical active ingredient. This further agrochemical active ingredient may be in any form, such as EC, SE (suspo-emulsion concentrate) or an SL (soluble liquid).

In the formulation of the present disclosure the component is encapsulated and provided as a microcapsule suspension in the aqueous phase. By encapsulated it is meant that the second agrochemical or solvent droplets are contained within a discrete barrier of polyurea which acts as a diffusion barrier. This polyurea wall is an asymmetrical membrane formed through in situ polymerization in which the second agrochemical or solvent is able to diffuse through when applied in the field. This membrane is highly cross-linked by the ratio of the monomers used to form it as well as the temperature of reaction used. This is to control the diffusion of the solvent or second agrochemical across it. The polyurea wall provides physical stability as well as a chemical balance of the components in the formulation.

Methods for encapsulating agrochemicals in such a manner are reported in the art—see for example U.S. Pat. Nos. 4,285,720, 4,280,833, 4,417,916, 4,534,783, 4,563,212 and 4,640,709.

In one embodiment, the formation of capsules is based on the Stauffer process. In such a process, isocyanates are provided which react with water to form carbamic acid. The carbamic acid decomposes into an amine and CO₂, and this amine then reacts with the remaining isocyanate to form polyurea on heating.

Chloroacetamide microcapsules can be produced in the following manner. An aqueous solution comprising appropriate emulsifiers and an optional polyamine is provided in a suitable vessel and stirred at a low speed. Preferred emulsifiers are lignosulfonate salts, especially sodium lignosulfonate. In a separate vessel the organic phase is prepared—which comprises combining the chloroacetanilide herbicide and an appropriate polyisocyanate. Preferred isocyanates are blend of toluene diisocyanate (TDI) and diphenylmethane-4,4′-diisocyanate (MDI)—wherein the mixture of MDI: TDI is approximately 3:1. The organic phase is then combined with the aqueous phase with continuous mixing. The particle size of the emulsion formed by mixing the aqueous and organic phase can range from about 1 micron to up to about 100 microns in diameter. A particle size range from about 7 to about 12 is preferred. A high shear blade can be used to achieve the desired particle size. Once the desired particle size is obtained the microcapsules are formed by appropriate heating of the mixture for an appropriate time. Typically, heating the mixture to 65-75° C. for approximately 3 hours will suffice. It should be appreciated that the ratio of diisocyanates and the polymerisation temperature should be selected so as to increase the polymer cross linking in order to form a tight capsule around the chloroacetamide and thus minimise the interaction of the chloroacetamide with the HPPD inhibitor or sulfonamide in the final formulation.

Unless otherwise stated are percentages are given as percentages by total weight and all embodiments and preferred features may be combined in any combination.

### EXAMPLES

Compositions according to the invention (Composition 1 and Composition 2) were prepared with the components as set out in Table 2, where the S-metolachlor was encapsulated (encapsulating material not provided) and the remaining active ingredients were in the continuous phase. The procedure for preparing the ZC is generally described in U.S. Pat. No. 9,468,213. The process generally involves, preparing an aqueous solution having an anionic/nonionic detergent blend (TOXIMULR 3465F (CAS: 64742-94-5:91-20-3) and a dispersant (lignosulfonic acid, sodium salt, sulfomethylated (CAS: 68512-34-5)) in water.

In a separate vessel preparing S-metolachlor (chloroacetamide) with benzene, 1,1′-methylenebis[-isocyanato-. isomers and homologs (CAS: 101-68-8:9016-87-9) and blending together uniformly.

The latter organic solution is then added to the aqueous solution and an emulsion is formed by the use of a high shear stirrer. The dispersed organic phase disperses into droplets that range from 3 to 40 microns in size. This emulsion is then heated to 70° C. and held for 4 hours to allow for the formation of microcapsules. Following the completion of the reaction the solution is then cooled to room temperature.

TABLE 2

| | Composition 1 (w/w) | Composition 2 (w/w) |
|---|---|---|
| S-metolachlor | 38.56 | 30.54 |
| metribuzin | 7.13 | 6.05 |
| cloransulam- | 0.72 | — |
| methyl | | |
| mesotrione | — | 3.17 |
| sulfentrazone | — | — |
| Surfactant blend | — | 11.96 |
| Capsule material | 4 (3.18 polymer) | 3.16 (2.47 polymer) |
| Emulsifying agent | 2.27 | — |
| Wetting Agent | 1.45 | 0.25 |
| Anti-freeze | 1.13 | 0.1 |
| Dispersing agent | 1.36 | 0.41 |
| Thickener | 0.14 | 2.13 |
| Biocide | 0.12 | 0.09 |
| Buffer | 0.2 | 1.02 |
| antifoam | 0.01 | 0.01 |
| Stabilizing agent | — | 0.94 |
| Water | Rest | Rest |

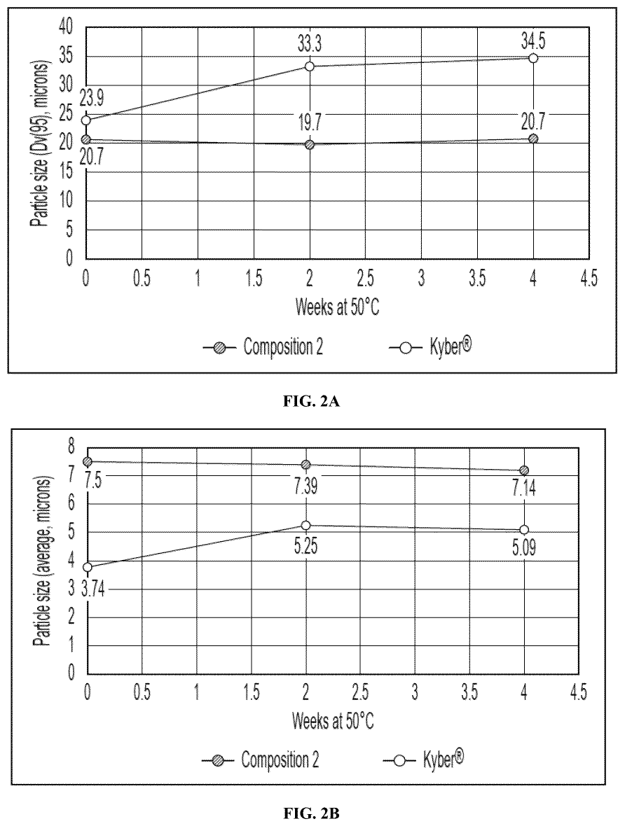

During testing, it was noticed that Composition 2 showed no increase in particle size, whereas Kyber® (a flumioxazin, pyroxasulfone, metribuzin suspension concentrate (SC)) from Corteva, which was compared to for benchmarking, showed significant particle size growth, as illustrated by FIGS. 2A, 2B, and Table 3 below.

TABLE 3

| | % change in particle | % change in |
|---|---|---|
| | size (Dv(95)) | particle size |
| | after 4 weeks | (average) after |
| | at 50° C. | 4 weeks at 50° C. |
| Composition 2 | 1.3 | −4.8 |
| Kyber ® | 44.4 | 36.1 |

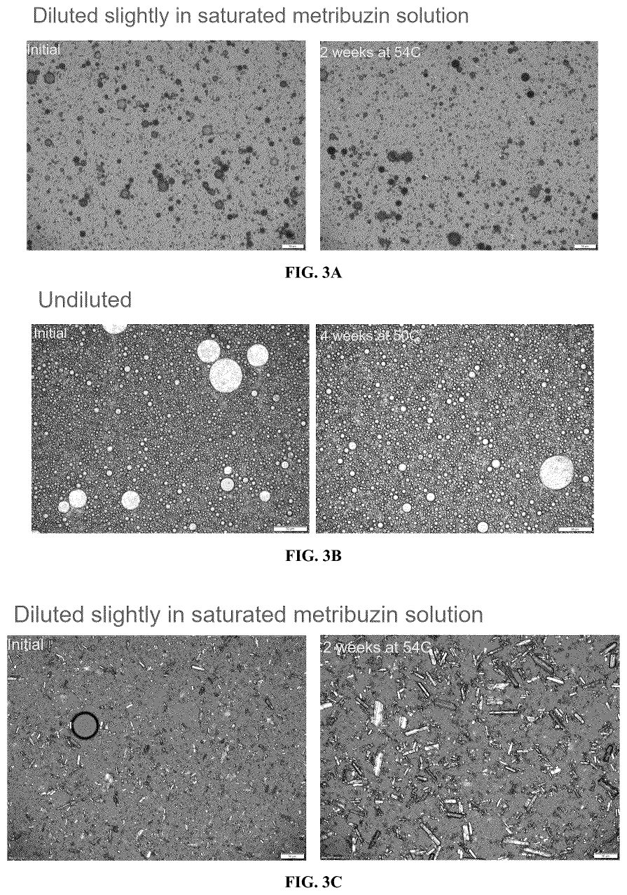

Further crystal growth studies were done with Composition 1 (FIG. 3B), Composition 2, and Kyber®. The images of FIGS. 3A-C, at 50-micron scale bar, show the difference in crystal growth between the three compositions. No crystal growth was observed in Composition 1 or Composition 2, whereas Kyber® showed significant crystal growth.

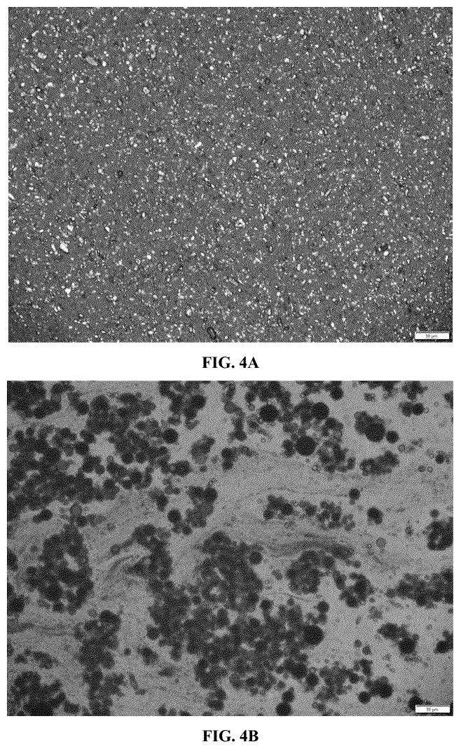

During further testing, Composition 2 was made with metribuzin being the only active ingredient (i.e., S-metolachlor and mesotrione were not present). An image, at 50-micron scale bar, is provided at FIG. 4A. To this formulation, the capsule suspension used in Composition 2 was added. As illustrated by FIG. 4B, an image at 50-micron scale bar, no metribuzin crystals appeared visible.

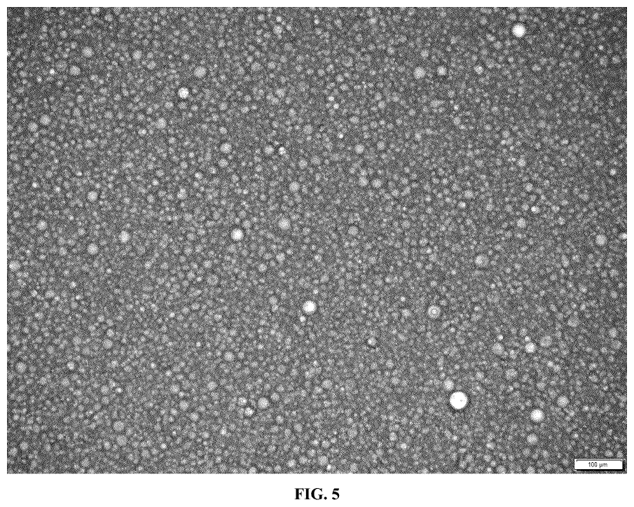

Further testing was done by replacing the metribuzin with sulfentrazone. In these tests sulfentrazone technical (powder, Dv(95)=307 microns) was added to a composition the CS of Composition 2 at a ratio of S-metolachlor:sulfentrazone of 10:0.8, and mixed for 1 hour at 30° C. to provide additional solubilization over room temperature. As illustrated in the image provided in FIG. 5, having 100-micron scale bar, no sulfentrazone crystals were observed.

Additional testing was done using two jars with S-metolachlor CS of Composition 2 and 8% sulfentrazone technical at a ratio of 10:0.08. One was mixed at room temperature and one at 30° C. for 1 hour. The results are provided in Table 4.

TABLE 4

| | | | % residue |
|---|---|---|---|
| Component | Dv(50) | Dv(95) | Wet sieve, 100 mesh |
| sulfentrazone | 30.3 | 307 | — |
| S-metolachlor CS | 9.51 | 26.2 | — |
| 1 hr 30 C. mixing | 9.62* | 30.0* | 0.04 |
| 1 hr RT mixing | 9.12* | 26.3* | 0.4 |

*Average of triplicates

The many features and advantages of the disclosure are apparent from the detailed specification, and thus, it is intended by the appended claims to cover all such features and advantages of the disclosure which fall within the true spirit and scope of the disclosure. Further, since numerous modifications and variations will readily occur to those skilled in the art, it is not desired to limit the disclosure to the exact construction and operation illustrated and described, and accordingly, all suitable modifications and equivalents may be resorted to, falling within the scope of the disclosure.

1. A composition, comprising:
a liquid continuous phase;
a first agrochemical active ingredient which is insoluble in the liquid continuous phase;
a second agrochemical active ingredient which dissolves the first agrochemical active ingredient encapsulated in a permeable capsule, the permeable capsule dispersed within the liquid continuous phase; and
a stabilizing amount of the second agrochemical active ingredient free in the liquid continuous phase which dissolves the first agrochemical active ingredient.

2. The composition of claim 1, wherein the second agrochemical active ingredient is an acetamide herbicide.

3. The composition of claim 1, wherein the second agrochemical active ingredient is a chloroacetanilide herbicide.

4. The composition of claim 1, wherein the second agrochemical active ingredient is S-metolachlor.

5. The composition of claim 1, wherein the first agrochemical active ingredient is metribuzin.

6. The composition of claim 1, wherein the first agrochemical active ingredient is sulfentrazone.

7. The composition of claim 1, wherein the continuous phase comprises water.

8. The composition of claim 1, wherein the free second agrochemical active ingredient is about 1 to 10% w/w of the composition.

9. The composition of claim 1, further comprising a third agrochemical active ingredient in the continuous phase.

10. The composition of claim 1, wherein the third agrochemical active ingredient is cloransulam-methyl or mesotrione.

11. The composition of claim 1, wherein the permeable capsule is from 3 to 40 microns, and the w/w ratio of capsule material to the second agrochemical active ingredient is 1:5 to 1:25, 1:8 to 1:18, 1:10 to 1:15, or about 1:12.

12. The composition of claim 1, further comprising:
one or more surfactants as wetting agents and/or emulsifiers and/or dispersants in an amount of from 1 to 15% w/w;
one or more thickeners in a range of 0.01 to 5% w/w;
one or more anti-freeze agents in a range of 0.01 to 5% w/w;
less than 1% w/w a biocide;
less than 1% w/w an antifoam agent; and
a buffer.

13. The composition of claim 1, wherein the first agrochemical active ingredient does not crystalize after 4-weeks at 50° C.

14. A method of weed control, comprising:
diluting the composition of claim 1; and
applying an herbicidal amount of the composition to a crop or the locus of the crop.

15. The method of claim 14, wherein the applying is pre-emergent.

16. A method, comprising:
encapsulating the second agrochemical active ingredient in a permeable capsule to form a first composition;
combining the first composition with the first agrochemical active ingredient to form a composition as defined in claim 1.

17. A composition, comprising:
a liquid continuous phase;
a first agrochemical active ingredient which is insoluble in the liquid continuous phase;
a solvent which dissolves the first agrochemical active ingredient encapsulated in a permeable capsule, the permeable capsule dispersed within the liquid continuous phase; and
a stabilizing amount of the solvent ingredient free in the liquid continuous phase which dissolves the first agrochemical active ingredient.
